(19) United States
(12) Patent Application Publication
(10) Pub. No.: US 2014/0071237 A1
(43) Pub. Date: Mar. 13, 2014

(54) IMAGE PROCESSING DEVICE AND METHOD THEREOF, AND PROGRAM

(71) Applicant: Sony Corporation, Tokyo (JP)

(72) Inventors: Nobuo Ueki, Tokyo (JP); Kazuhiko Nishibori, Kanagawa (JP)

(73) Assignee: Sony Corporation, Tokyo (JP)

(21) Appl. No.: 14/115,043

(22) PCT Filed: Jun. 8, 2012
(86) PCT No.: PCT/JP2012/003764

§ 371 Date: Oct. 31, 2013

(30) Foreign Application Priority Data
Jun. 15, 2011 (JP) 2011-132865

(51) Int. Cl. H04N 13/04

(52) U.S. Cl. CPC H04N 13/047; H04N 13/0409
USPC 348/43

(57) ABSTRACT

An apparatus may include a hardware processor and a storage medium. The storage medium may be coupled to the processor, and may store instructions. When executed by the processor, the instructions may cause the apparatus to determine a number of viewers. The instructions may also cause the apparatus to calculate a number of viewpoints based on the number of viewers. Additionally, the instructions may cause the apparatus to generate a plurality of images corresponding to the viewpoints.

### TECHNICAL FIELD

The present technology relates to an image processing device and method thereof, and a program, and particularly, to an image processing device and method thereof, and a program in which multi-viewpoint images can be viewed at an appropriate resolution corresponding to the number of viewers, when a glasses-free three-dimensional stereoscopic image with two viewpoints, which is an input image, is input.

### BACKGROUND ART

As a glasses-free image display device in which stereoscopic images can be viewed without using special glasses, a parallax barrier system (for example, refer to PTL 1) or a lenticular lens system (for example, refer to PTL 2) is well known.

### CITATION LIST

### Patent Literature

PTL 1: PTL 1: Japanese Unexamined Patent Application Publication No. 7-5420
PTL 2: Japanese Unexamined Patent Application Publication No. 5-49044

### SUMMARY OF INVENTION

### Technical Problem

Meanwhile, in both cases of the above described two-lens parallax barrier system, or the lenticular system, since pixels are divided into a right eye pixel and a left eye pixel, and display a right eye image and a left eye image respectively, the resolution thereof is halved. For this reason, when it is configured to be viewed from multiple viewpoints so as to correspond to the direction of view of more multiple viewers, the resolution thereof is further reduced.

However, there may be a case where a single viewer views images with low resolution by enabling viewing from multiple viewpoints, for example, regardless of there being only one viewer, and when viewing from multiple viewpoints is not necessarily needed.

The present technology has been made in view of this situation, and particularly, is to enable viewing images from multiple viewpoints at the appropriate resolution corresponding to the number of viewers, when glasses-free three-dimensional stereoscopic image with two viewpoints as the input image is input.

### Solution to Problem

There is disclosed an apparatus, which may include a hardware processor and a storage medium. The storage medium may be coupled to the processor, and may store instructions. When executed by the processor, the instructions may cause the apparatus to determine a number of viewers. The instructions may also cause the apparatus to calculate a number of viewpoints based on the number of viewers. Additionally, the instructions may cause the apparatus to generate a plurality of images corresponding to the viewpoints.

There is also disclosed a method. The method may include determining a number of viewers. The method may also include calculating a number of viewpoints based on the number of viewers. Additionally, the method may include generating a plurality of images corresponding to the viewpoints.

In addition, there is disclosed a non-transitory, computer-readable storage medium storing instructions. When executed by a processor, the instructions may cause an apparatus to determine a number of viewers. The instructions may also cause the apparatus to calculate a number of viewpoints based on the number of viewers. Additionally, the instructions may cause the apparatus to generate a plurality of images corresponding to the viewpoints.

### BRIEF DESCRIPTION OF DRAWINGS

FIG. 1 is a block diagram which shows a configuration example of a first embodiment of an image processing device to which the present technology is applied.

FIG. 2 is a flowchart which describes display processing of a multi-viewpoint image according to the image processing device in FIG. 1.

FIG. 3 is a diagram which describes the display processing of the multi-viewpoint image.

FIG. 4 is a diagram which describes a method of calculating the pitch of a slit of a parallax barrier.

FIG. 5 is a block diagram which shows a configuration example of a second embodiment of the image processing device.

FIG. 6 is a flowchart which describes a display processing of a multi-viewpoint image according to the image processing device in FIG. 5.

FIG. 7 is a diagram which describes the display processing of the multi-viewpoint image which corresponds to a position of a viewer.

FIG. 8 is a diagram which describes a display example of the multi-viewpoint image which corresponds to the position of the viewer.

FIG. 9 is a block diagram which shows a configuration example of a third embodiment of the image processing device.

FIG. 10 is a flowchart which describes display processing of the multi-viewpoint image according to the image processing device in FIG. 9.

FIG. 11 is a diagram which describes a configuration example of a general-purpose personal computer.

### DESCRIPTION OF EMBODIMENTS

Hereinafter, embodiments for embodying the present technology (hereinafter, referred to as “embodiment”) will be described. In addition, the description will be made in the following order.

1. First embodiment (an example where parallax barrier is used)

2. Second embodiment (an example where position information of viewer is used)

3. Third embodiment (an example where lenticular lens is used)

### 1. First Embodiment

### Image Processing Device which Uses Parallax Barrier

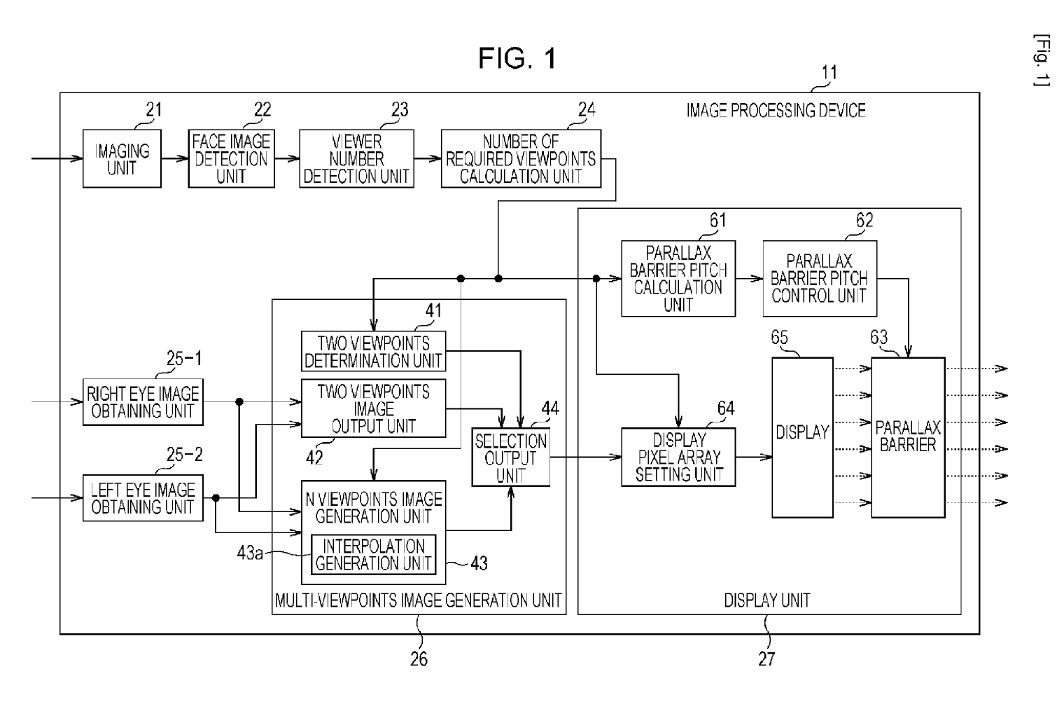

FIG. 1 shows a configuration example of a first embodiment of an image processing device to which the present technology is applied. The image processing device 11 in FIG. 1 displays an image which can be viewed as three-dimensional stereoscopic image using the naked eye with a predetermined parallax, which is an input image of a right eye image and left eye image, as a multi-viewpoint image at an appropriate resolution based on the number of viewers, and is a TV receiver, or the like.

The image processing device 11 in FIG. 1, includes an imaging unit (i.e., a software module, a hardware module, or a combination of a software module and a hardware module) 21, a face image detection unit 22, a viewer number detection unit 23, a required viewpoint number calculation unit 24, a right eye image obtaining unit 25-1, left eye image obtaining unit 25-2, a multi-viewpoint image generation unit 26, and a display unit 27.

The imaging unit 21 captures an image in the direction in which a viewer views an image which is displayed by the image processing device 11 (i.e., a viewer image), and supplies the image to the face image detection unit 22.

The face image detection unit 22 extracts information on facial contour of a human body, or eyes, ears, a nose, a mouth, or the like as organs, as a detectable feature amount from the supplied image, specifies as a rectangular face image, and supplies the specified face image to the viewer number detection unit 23 along with the captured image.

The viewer number detection unit 23 obtains the number of obtained face images, detects this as the number of viewers, and supplies the information on the number of viewers as the detection result to the required viewpoint number calculation unit 24, when the face image which is supplied from the face image detection unit 22 is obtained.

The required viewpoint number calculation unit 24 calculates the number of required viewpoints which is required when configuring a multi-viewpoint image on the basis of the information on the number of viewers which is supplied from viewer number detection unit 23, and supplies the number of required viewpoints to the multi-viewpoint image generation unit 26, and the display unit 27. The viewer is assumed to be present at a regular interval in the horizontal direction with respect to the displayed image. In addition, in order to make the viewer be able to view a three-dimensional stereoscopic image, a left eye image and a right eye image are set, respectively, for each viewer. In addition, a second viewer who is present on the left side of the first viewer uses the left eye image of the first viewer as his own right eye image. Further, similarly to this, a third viewer who is present on the right side of the first viewer uses the right eye image of the first viewer as his own left eye image. Accordingly, for example, when the viewers are three, the required number of viewpoints is four.

The right eye image obtaining unit 25-1, and the left eye image obtaining unit 25-2 respectively obtains the input right eye image and left eye image which are three-dimensional and stereoscopic, supplies the images to the multi-viewpoint image generation unit 26.

The multi-viewpoint image generation unit 26 generates a multi-viewpoint image from the input right eye image and left eye image which are supplied from the right eye image obtaining unit 25-1, and the left eye image obtaining unit 25-2, on the basis of the information on the number of required viewpoints which is supplied from the required viewpoint number calculation unit 24, and supplies the image to the display unit 27.

More specifically, the multi-viewpoint image generation unit 26 is configured by a two-viewpoint determination unit 41, a two-viewpoint image output unit 42, an N-viewpoint image generation unit 43, and a selection output unit 44. The two-viewpoint determination unit 41 determines whether or not the number of required viewpoints which is supplied from the required viewpoint number calculation unit 24 is two-viewpoints, and supplies the determination result to the selection output unit 44. The two-viewpoint image output unit 42 supplies the right eye image and the left eye image, which are supplied from the right eye image obtaining unit 25-1, and the left eye image obtaining unit 25-2 as are to the selection output unit 44. The N-viewpoint image generation unit 43 generates images by the number of required viewpoints using an interpolation or extrapolation, by controlling an interpolation generation unit 43a, using the right eye image and the left eye image (i.e., other images), which are supplied from the right eye image obtaining unit 25-1, and the left eye image obtaining unit 25-2, on the basis of the information on the number of required viewpoints which is supplied from the required viewpoint number calculation unit 24, and supplies the image to the selection output unit 44. The selection output unit 44 outputs the two-viewpoint image which is formed of the right eye image and the left eye image which are supplied from the two-viewpoint image output unit 42 to the display unit 27 as they are, when the number of required viewpoints is two, on the basis of the determination result which is supplied from the two-viewpoint determination unit 41. On the other hand, when the number of required viewpoints is not two, the selection output unit 44 outputs the multi-viewpoint image which is generated by the N-viewpoint image generation unit 43 to the display unit 27, on the basis of the determination result which is supplied from the two-viewpoint determination unit 41.

The display unit 27 controls a pitch (the gap) of a slit of a parallax barrier 63, on the basis of the information on the number of required viewpoints which is supplied from the required viewpoint number calculation unit 24, displays the two-viewpoint image which is supplied from the multi-viewpoint image generation unit 26, or the multi-viewpoint image, and displays the multi-viewpoint image through the parallax barrier 63.

More specifically, the display unit 27 includes a parallax barrier pitch calculation unit 61, a parallax barrier pitch control unit 62, the parallax barrier 63, a display pixel array setting unit 64, and a display 65. The parallax barrier pitch calculation unit 61 calculates the slit with the pitch (the gap of slit) in the vertical direction in which light which is emitted from the display 65 is transmitted using the parallax barrier 63, according to the number of required viewpoints which is calculated by the required viewpoint number calculation unit 24, and supplies the pitch to the parallax barrier pitch control unit 62. The parallax barrier pitch control unit 62 controls the operation of the parallax barrier 63 so as to configure the slit in the corresponding vertical direction, on the basis of the pitch (the gap of slit) of the parallax barrier which is calculated by the parallax barrier pitch calculation unit 61.

The parallax barrier 63 is formed of, for example, a liquid crystal panel or the like, and configures slits in the vertical direction at a pitch which is controlled by the parallax barrier pitch control unit 62. More specifically, the parallax barrier 63, for example, configures a shielding region with respect to a region other than a region which configures the vertical slit using liquid crystal, configures a parallax barrier by setting only the slit region as a light transmission region, and functions as the parallax barrier. The display pixel array setting unit 64 separates the generated multi-viewpoint image to slit shapes in a unit of pixel column, according to the number of required viewpoints which is supplied from the required viewpoint number calculation unit 24, arranges the multi-viewpoint image with the slit shape in the reverse direction with respect to the line of sight direction, and displays on the display 65. The display 65 is formed of a liquid crystal display (LCD), a plasma display, an organic EL, or the like, and displays an image by causing colors to be emitted using a pixel value which is supplied from the display pixel array setting unit 64.

### Display Processing of Multi-Viewpoint Image by Image Processing Device in FIG. 1

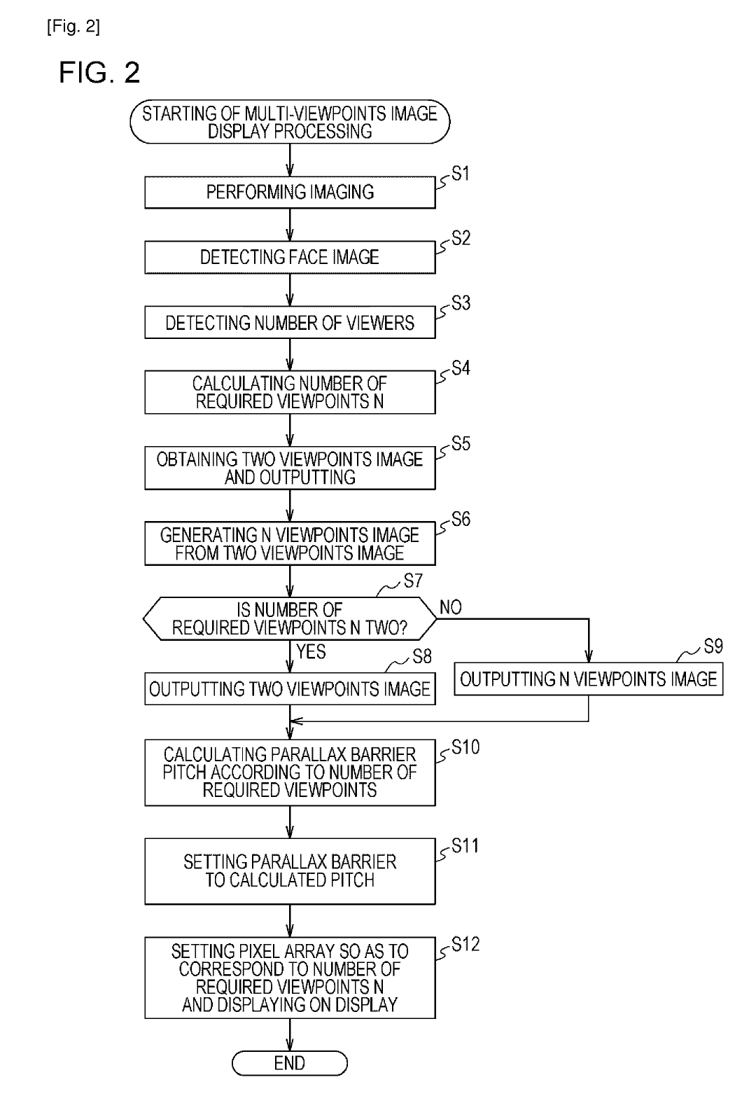

Subsequently, display processing of the multi-viewpoint image by an image processing device 11 in FIG. 1 will be described with reference to the flowchart in FIG. 2.

In step S1, the imaging unit 21 captures an image in the direction in which the viewer is present, that is, in the direction facing the image which is displayed by the display unit 27, and supplies the captured image to the face image detection unit 22.

In step S2, the face image detection unit 22 detects a rectangular face image by extracting a feature amount which is required when detecting the face image from the supplied image, and supplies the rectangular face image to the viewer number detection unit 23 along with the captured image.

In step S3, the viewer number detection unit 23 detects the number of viewers on the basis of the number of the supplied face images, and supplies the detected information on the number of viewers to the required viewpoint number calculation unit 24.

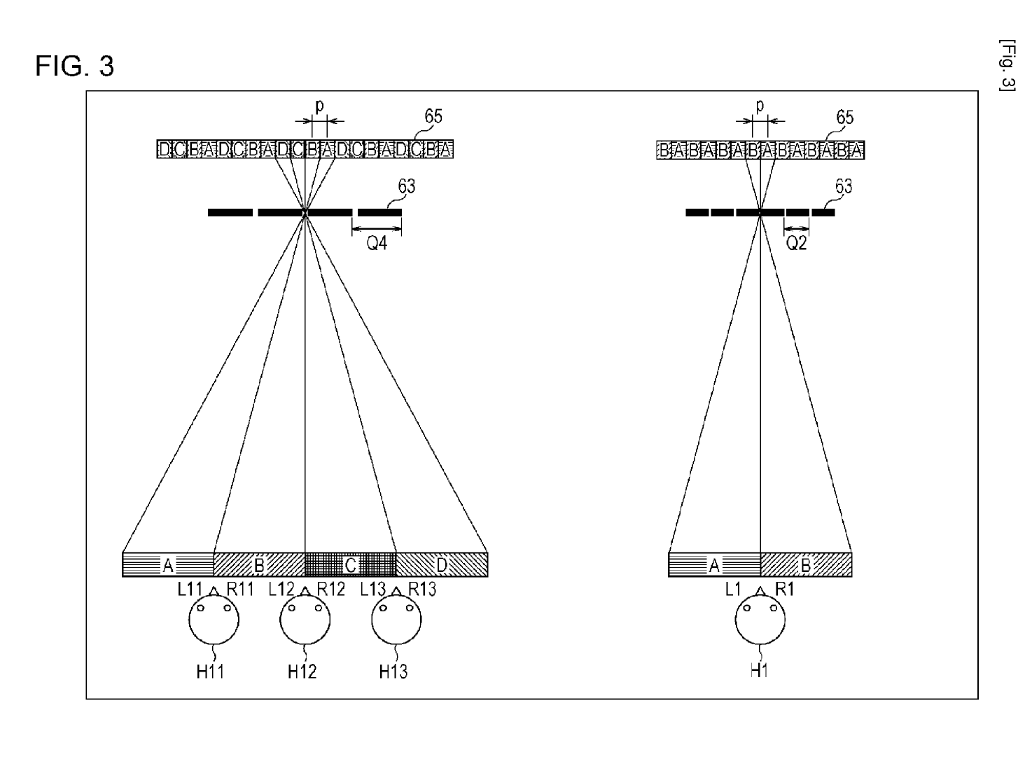

In step S4, the required viewpoint number calculation unit 24 calculates the number of required viewpoints N on the basis of the information on the number of viewers which is supplied from the viewer number detection unit 23. That is, for example, when the number of viewers is one, as shown on the right in FIG. 3, the number of required viewpoints is total of two-viewpoints of a left eye viewpoint L1 of a viewer H1 who is present at a position facing the display direction of the display 65 and the parallax barrier 63, and a right eye viewpoint R1. In this case, it is necessary to have a viewpoint image A as the left eye image, and a viewpoint image B as the right eye image for each of the viewpoints L1 and R1 of the viewer H. On the other hand, as shown on the left in FIG. 3, when the number of viewers is three, the number of required viewpoints becomes the left eye viewpoints and the right eye viewpoints, respectively, of viewers H11 to H13 which are present at a position facing the display 65 and the parallax barrier 63. Here, the viewers H11 to H13 are assumed to be present at a regular interval on the face facing the display 65 and the parallax barrier 63. That is, the viewpoints necessary for the viewer H11 are the left eye viewpoint L11, and the right eye viewpoint R11. In addition, the viewpoints necessary for the viewer H12 are the left eye viewpoint L12, and the right eye viewpoint R12. Further, the viewpoints necessary for the viewer H13 are the left eye viewpoint L13, and the right eye viewpoint R13. Accordingly, in this case, a viewpoint image A is necessary as the left eye image for the viewpoint L11 of the viewer H11, and a viewpoint image B is necessary as the right eye image for the viewpoint R11 of the viewer H11, and as the left eye image for the viewpoint L12 of the viewer H12. In addition, a viewpoint image C is necessary as the right eye image for the viewpoint R12 of the viewer H12, and as the left eye image for the viewpoint L13 of the viewer H13, and viewpoint image D is necessary as the right eye image for the viewpoint R13 of the viewer H13.

That is, when considering the viewer H12 as a reference, the viewpoint R11 as the right eye image of the viewer H11 on the immediate left of the viewer H12, and the viewpoint L12 as the left eye image of the viewer H12 are the same as each other. In addition, the viewpoint L12 as the left eye image of the viewer H13 on the immediate right of the viewer H12, and the viewpoint R12 as the right eye image of the viewer H12 are the same as each other.

As a result, when the number of viewers is three, the required number of viewpoints N becomes four. In addition, even when the number of viewers is different from this, the viewpoints of each viewer have a configuration in which the viewpoint of the left eye image is shared with the viewer who is present on the immediate right, and the right eye image is shared with the viewer who is present on the immediate left, respectively. In addition, in FIG. 3, all of A to D which are attached onto the display 65 denote the pixel array in which an image corresponding to the viewpoint images A to D are divided into slit shapes in the vertical direction in pixel units. In addition, in the parallax barrier 63, the solid line is a light shielding region, and the gap thereof is the slit, and is the transmission region of light which is emitted from the display 65. Further, Q2 and Q4 of the parallax barrier 63 in FIG. 3 denote the pitch of the slit (gap) when the number of required viewpoints N are two and four, respectively. In the display 65, p denotes the pitch of the pixel (gap).

In step S5, the two-viewpoint image output unit 42 of the multi-viewpoint image generation unit 26 outputs the right eye image which is supplied from the right eye image obtaining unit 25-1, and the left eye image which is supplied from the left eye image obtaining unit 25-2, as the two-viewpoint image as are to the selection output unit 44.

In step S6, the N-viewpoint image generation unit 43 of the multi-viewpoint image generation unit 26 generates an N-viewpoint image according to the number of required viewpoints from the right eye image which is supplied from the right eye image obtaining unit 25-1, and the left eye image which is supplied from the left eye image obtaining unit 25-2. In addition, the N-viewpoint image generation unit 43 outputs the generated N-viewpoint image to the selection output unit 44.

More specifically, the N-viewpoint image generation unit 43 obtains the viewpoint images A and D, using the extrapolation of the viewpoint images B and C, respectively, since the viewpoint images B and C are the input two-viewpoint images, for example, when the number of required viewpoints is four, as shown on the left portion in FIG. 3. In addition, when the number of required viewpoints is three, as shown on the left portion in FIG. 3, the N-viewpoint image generation unit 43 generates images of new three types of viewpoints, using the interpolation in between the viewpoints A and B, B and C, and C and D, after generating the images of the viewpoints A to D as the four viewpoints. In addition, when the horizontal resolution of the input image is 1920 pixels, the horizontal resolution of each viewpoints image becomes 960 pixels in a case of the two-viewpoint image, and further, the horizontal resolution of each viewpoints image becomes 480 pixels in a case of the four-viewpoint image. However, since the multi-viewpoint image is not formed unnecessarily according to the number of required viewpoints, it is possible to generate the viewpoints image with an appropriate horizontal resolution according to the number of required viewpoints.

In step S7, the two-viewpoint determination unit 41 determines whether or not the number of required viewpoints N is two. In step S7, when the number of required viewpoints N is two in step S8, the two-viewpoint determination unit 41 supplies the fact that the number of required viewpoints N is two to the selection output unit 44. The selection output unit 44 supplies the two-viewpoint image as the input image supplied from the two-viewpoint image output unit 42 to the display unit 27 as are, since the determination result supplied from the two-viewpoint determination unit 41 is the two-viewpoint image.

On the other hand, in step S7, when the number of required viewpoints N is not two, the selection output unit 44 supplies the N-viewpoint image which is supplied from the N-viewpoint image generation unit 43 to the display unit 27, in step S9.

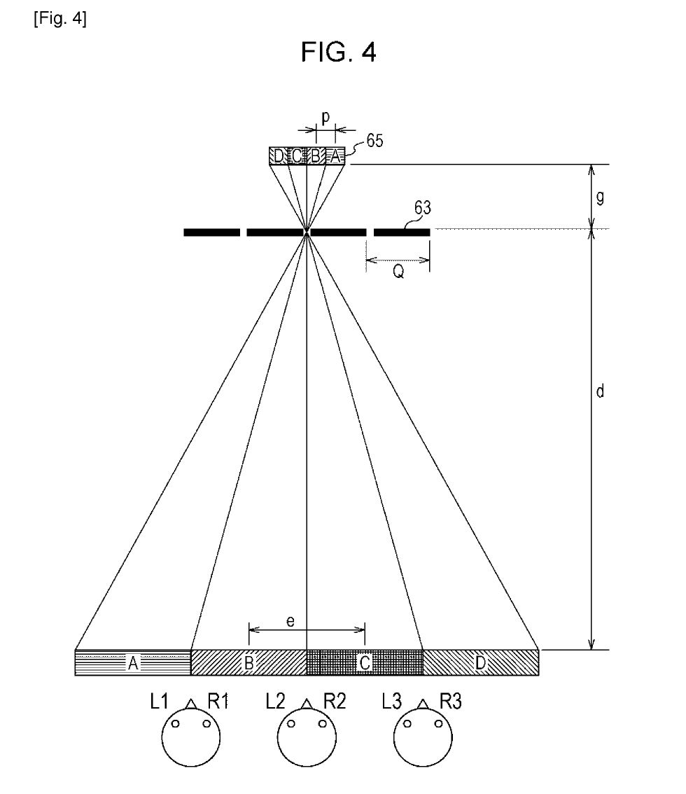

In step S10, the parallax barrier pitch calculation unit 61 of the display unit 27 calculates the pitch of the slit (gap) in the parallax barrier 63 according to the number of required viewpoints N, and supplies the calculation result to the parallax barrier pitch control unit 62. More specifically, the pitch of the slit in the parallax barrier 63 is set so as to satisfy the relationship between the following expressions (1) and (2), by the display 65 shown in FIG. 4, the parallax barrier 63, and the respective viewpoints images of the viewers H11 to H13.

e:p=d:g (1)

Q:d=N×p:(d+g) (2)

Here, e denotes the distance between the left eye and right eye of each viewer, and p denotes a pitch between pixels (gap) of the display 65, d denotes the distance from the parallax barrier 63 to a measurement position of the viewer, and g denotes the distance between the parallax barrier 63 (slit thereof: opening portion) and the display 65. In addition, Q denotes the pitch of the slit (gap) of the parallax barrier 63, and N denotes the number of required viewpoints.

As a result, the pitch Q of the slit of the parallax barrier is obtained by calculating the following expression (3).

Q=(d×N×p)/(d+g) (3)

In step S11, the parallax barrier pitch control unit 62 controls a panel of the parallax barrier 63, and sets so as to provide the slit at a pitch which is supplied from the parallax barrier pitch calculation unit 61. At this time, in the parallax barrier 63, the slit is set such that a slit is provided at the center portion, and the subsequent slit is provided at a pitch (gap) which is supplied from the parallax barrier pitch calculation unit 61 having the center slit as the reference.

In step S12, the display pixel array setting unit 64 divides the two-viewpoint image, or the N-viewpoint image which is supplied from the selection output unit 44 into the slit shapes in the unit of pixel column as shown in FIG. 3, arranges the pixel column so as to reverse the arrangement order in the transverse direction, and displays on the display 65.

That is, for example, as shown on the left in FIG. 3, when the viewpoint images A to D are set from the left in FIG. 3, at a position where the viewers H11 to H13 view, in the pixel column array on the display 65, the image in the line of sight direction corresponding to the viewpoint images A to D which are divided into the slit shapes in the unit of pixel column is repeatedly arranged from images D to A in the order which is transversely reversed.

According to the above described processing, the viewers H11 to H13 are able to view the three-dimensional stereoscopic image at any position, even when viewing the image displayed on the display unit 27 at different viewpoints, respectively. For this reason, when it is an image with a horizontal resolution of 1920 pixels, if the number of required viewpoints N is four, each viewpoint image becomes 480 pixels, and if the number of required viewpoints N is two, each viewpoint image becomes 960 pixels. That is, since the horizontal resolution with which each viewer views the image varies according to the number of viewers, it is possible to view the stereoscopic image of multi-viewpoints with the appropriate resolution according to the number of viewers.

### 2. Second Embodiment

### Image Processing Device Using Viewer Position

As described above, an example where the N-viewpoint image is generated and displayed according to the number of required viewpoints which is set by the number of viewers from the two-viewpoint image as the input image, however, when the multi-viewpoint image which is different due to the viewpoint position is generated, the two-viewpoint image corresponding not only to the number of viewers, but to the position of the viewer may be selected and displayed.

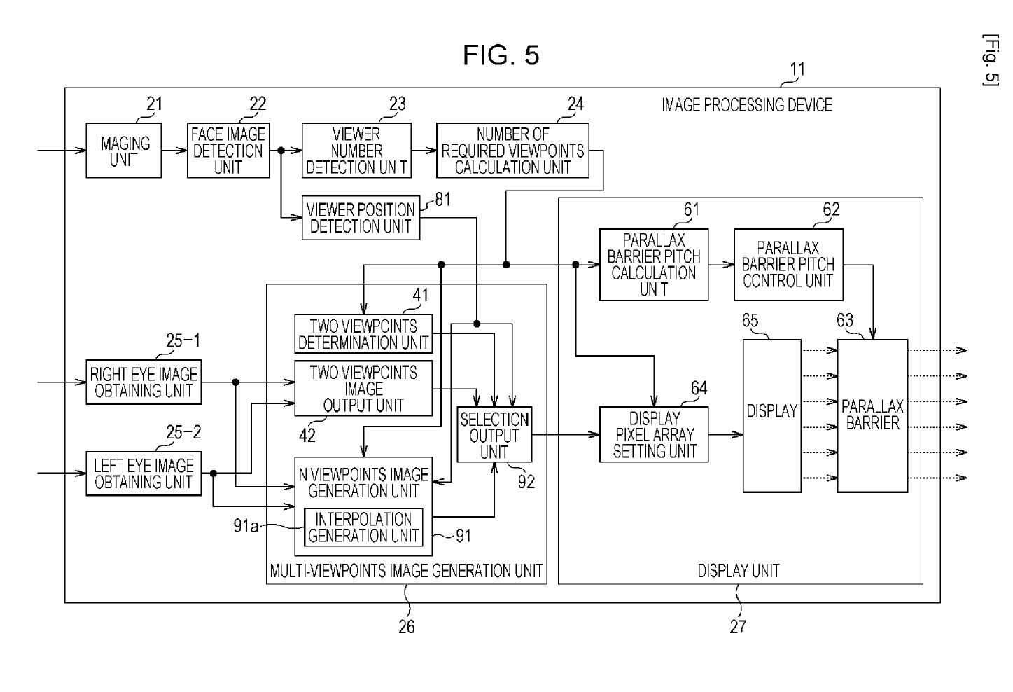

FIG. 5 is a configuration example of a second embodiment of an image processing device in which the two-viewpoint image corresponding not only to the number of viewers, but to the position of the viewer is generated and displayed. In addition, in the image processing device 11 in FIG. 5, regarding the configuration with the same function as that of the image processing device 11 in FIG. 1 will be given with the same name and reference numerals, and descriptions thereof will be omitted.

That is, in the image processing device 11 in FIG. 5, the difference from the image processing device 11 in FIG. 1 is that the image processing device 11 in FIG. 5 newly includes a viewer position detection unit 81. In addition, in a multi-viewpoint image generation unit 26, an N-viewpoint image generation unit 91 and a selection output unit 92 are provided instead of the N-viewpoint image generation unit 43 and the selection output unit 44.

The viewer position detection unit 81 detects positions of a face image which is formed of a rectangular image supplied from a face image detection unit 22, and a face image which is formed of a rectangular image, on the basis of the inside of the captured image, and detects this as the position of viewers. The viewer position detection unit 81 supplies the detected information on the position of viewers to the multi-viewpoint image generation unit 26.

The N-viewpoint image generation unit 91 of the multi-viewpoint image generation unit 26 generates a multi-viewpoint image using the right eye image and the left eye image of the two-viewpoint image which corresponds to the position of each viewer, on the basis of the position of the viewer supplied from the viewer position detection unit 81, and the information on the number of required viewpoints N. In addition, the N-viewpoint image generation unit 91 supplies to a generated selection output unit 92.

The selection output unit 92 has the same basic function as that of the selection output unit 44, however, outputs the two-viewpoint image which is supplied from a two-viewpoint image output unit 42 to the display unit 27, only when it is determined as the two-viewpoints by a two-viewpoint determination unit 41, and further, the viewer is present in the front with respect to the display unit 27 on the basis of the information on the position of the viewer.

### Multi-Viewpoints Image Display Processing by Image Processing Device 11 in FIG. 5

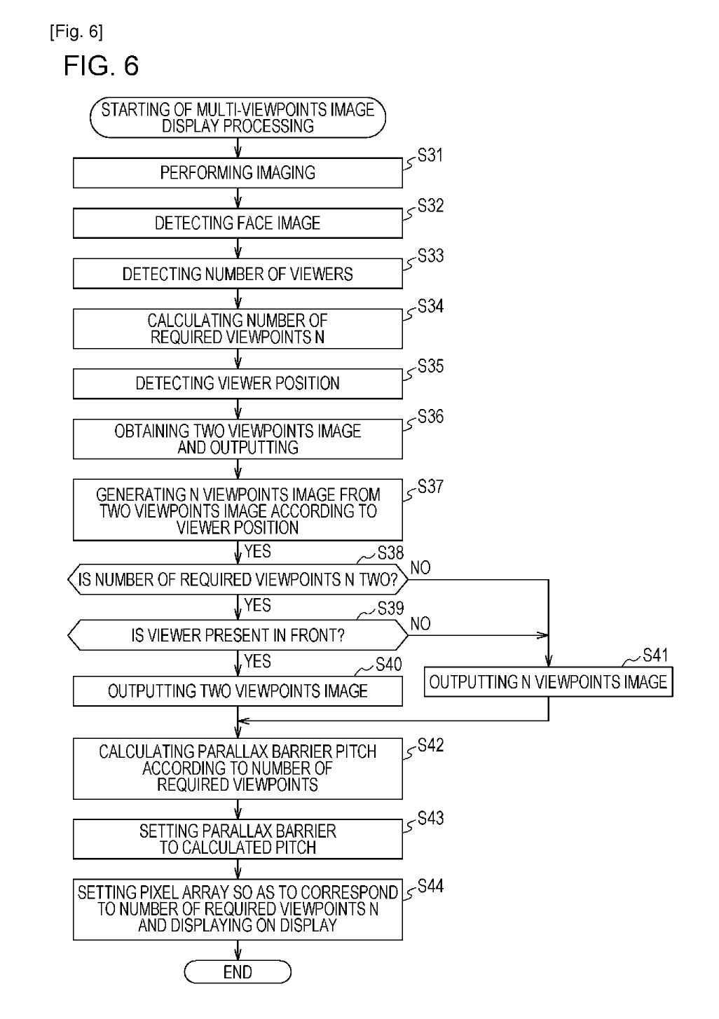

Subsequently, display processing of the multi-viewpoint image by the image processing device 11 in FIG. 5 will be described with reference to the flowchart in FIG. 6. In addition, processing of steps S31 to S34, S36 and, S40 to S45 in the flowchart in FIG. 6 are the same as that of steps S1 to S5, and S8 to S12 which are described with reference to the flowchart in FIG. 2, descriptions thereof will be omitted.

That is, when the number of required viewpoints is obtained by the processing of steps S31 to S34, in step S35, the viewer position detection unit 81 detects the position of the viewer on the basis of the position of the face image in the image which is formed of a rectangular image supplied from the face image detection unit 22, and supplies the information on the detected position of viewer to the multi-viewpoint image generation unit 26.

In step S36, the two-viewpoint image output unit 42 supplies the right eye image and the left eye image which are supplied from a right eye image obtaining unit 25-1 and left eye image obtaining unit 25-2 to the selection output unit 92 as are.

In step S37, the N-viewpoint image generation unit 91 generates the two-viewpoint image which corresponds to the position of the viewer, on the basis of the information on the position of the viewer supplied from the viewer position detection unit 81, and the number of required viewpoints N, and supplies the image to the selection output unit 44.

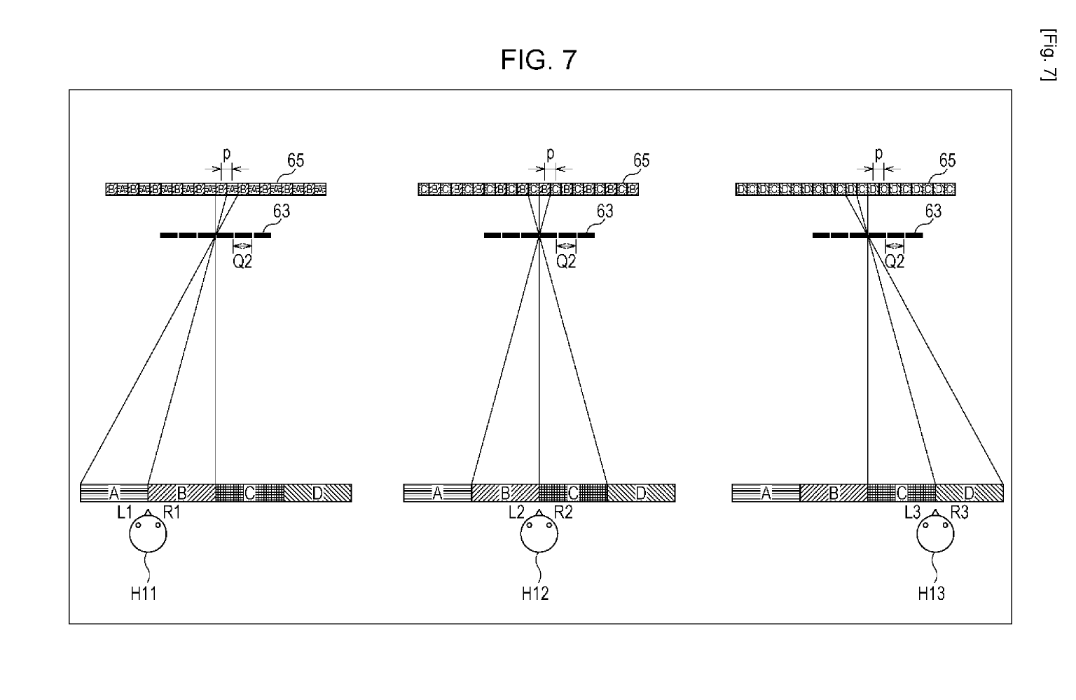

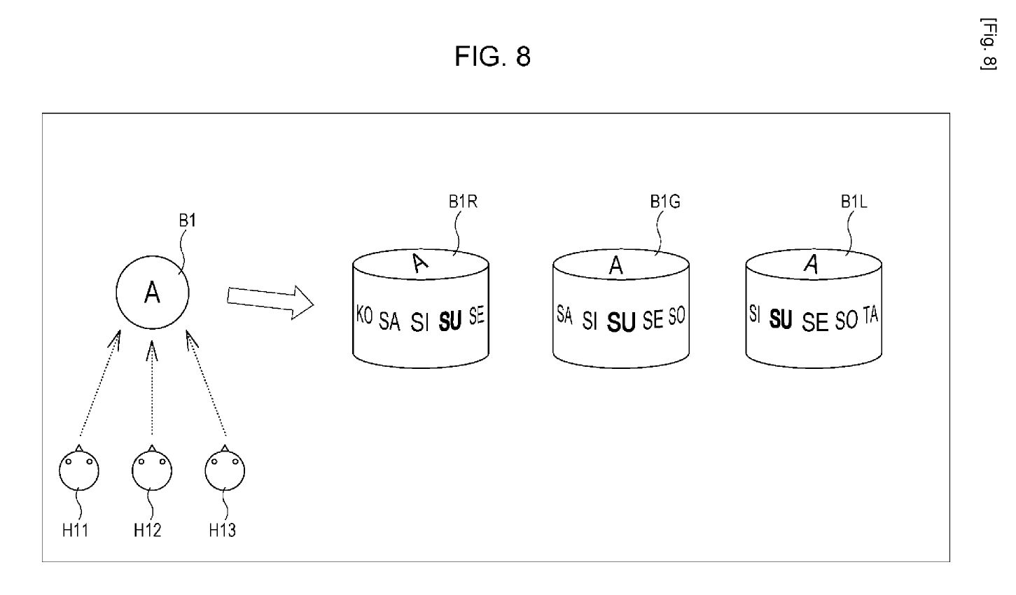

That is, when the viewer is one, for example, viewers H11 to H13 who are present on the left, at the center, and on the right in FIG. 7 are viewing the parallax barrier 63 and the display 65 in the different direction from each other, respectively. That is, the viewers H11 to H13 view the parallax barrier 63 and the display 65 in the right-hand direction, the front direction, and the left-hand direction from their own position, respectively. It is assumed that a multi-viewpoint image is obtained in a multi-viewpoint image obtaining unit 82 at a position where the display 65 and the parallax barrier 63 are present, in which, for example, as shown on the left in FIG. 8, a cylindrical object B1 with a description of “A” on the upper base, and with a description of “Ko, Sa, Si, Su, Se, So, and Ta” on the side thereof, counterclockwise when viewed from the upper base is displayed. In this case, as shown on the left in FIG. 8, the viewers H11 to H13 are viewing the object B1 in the right-hand direction, the front direction, and the left-hand direction, respectively. That is, it matches the positional relationship where the viewers H11 to H13 are viewing the display 65 and the parallax barrier 63, in FIG. 7.

Therefore, the N-viewpoint image generation unit 91 generates a two-viewpoint image in which the object B1R on the right in FIG. 8 is stereoscopically viewed, when information on the viewer is supplied at a position where the display 65 and the parallax barrier 63 are viewed in the right-hand direction as the viewer H11 shown on the left in FIG. 7, by generating the viewpoint images of A and B shown in FIG. 7 from the two-viewpoint image as the input image using the extrapolation, and supplies to the selection output unit 92.

In addition, the N-viewpoint image generation unit 91 generates a two-viewpoint image in which the object B1C on the right in FIG. 8 is stereoscopically viewed, when information on the viewer is supplied at a position where the display 65 and the parallax barrier 63 are viewed in the front direction as the viewer H12 shown at the center in FIG. 7, by generating the viewpoint images of B and C shown in FIG. 7 from the two-viewpoint image as the input image using the extrapolation, and supplies to the selection output unit 92.

In addition, the N-viewpoint image generation unit 91 generates a two-viewpoint image in which the object B1L on the right in FIG. 8 is stereoscopically viewed, when information on the viewer is supplied at a position where the display 65 and the parallax barrier 63 are viewed in the left-hand direction as the viewer H13, by generating the viewpoint images of C and D shown in FIG. 7 from the two-viewpoint image as the input image using the extrapolation, and supplies to the selection output unit 92.

For this reason, as shown in FIG. 8, for the viewer H11 who is viewing the display 65 and the parallax barrier 63 in the right-hand direction, as in a case where the object B1 is viewed in the right-hand direction, it is possible make the object B1 be viewed as shown in the object B1R in which the thick character “Su” which is viewed in the front is viewed as if it is shifted by being rotated to the right, when the object B1 is viewed in the right-hand direction. In addition, for the viewer H12 who is viewing the display 65 and the parallax barrier 63 in the front direction, as in a case where the object B1 is viewed in the front direction, it is possible make the thick character “Su” be viewed in the front as shown in the object B1C, when the object B1 is viewed in the front direction. Further, for the viewer H13 who is viewing the display 65 and the parallax barrier 63 in the left-hand direction, as in a case where the object B1 is viewed in the left-hand direction, it is possible make the object B1 be viewed as shown in the object B1L in which the thick character “Su” which is viewed in the front is viewed as if it is shifted by being rotated to the left, when the object B1 is viewed in the left-hand direction.

In addition, in step S38, when the number of required viewpoints is two, in step S39, the selection output unit 92 determines whether or not the position of the viewer which is supplied from the viewer position detection unit 81 is the center position. For example, in the step S39, when the position of the viewer is the center position, the selection output unit 92 outputs the two-viewpoint image as the input image which is supplied from the two-viewpoint image output unit 42 to the display unit 27 as are, in step S40. In addition, in step S39, when the position of the viewer which is supplied from the viewer position detection unit 81 is not the center position, the selection output unit 92 outputs the N-viewpoint image which is supplied from the N-viewpoint image generation unit 91 to the display unit 27, in step S41.

As a result, it is possible to realize the three-dimensional stereoscopic view corresponding to the direction in which the viewer is viewing, in the display 65 and the parallax barrier 63. In addition, when the plurality of viewers are present at a separated position, the N-viewpoint image generation unit 91 is able to realize the appropriate three-dimensional stereoscopic view for each position of the plurality of viewers, by generating the required two-viewpoint image by the number of viewers at the position of each viewer. In this case, since the multi-viewpoint image can be shared as much as possible when the plurality of viewers can share the multi-viewpoint image, and it is possible to reduce the necessary images as the multi-viewpoint image, degradation of the resolution can be suppressed.

As described above, when the multi-viewpoint image is generated, it is possible to make the image be viewed as if the positional relationship with the object which is three-dimensionally stereoscopically viewed is also changed, by selecting and displaying the two-viewpoint image corresponding to the viewing position of the viewer with respect to the display 65 and the parallax barrier 63.

### 3. Third Embodiment

### Image Processing Device Using Lenticular Lens

As described above, the example of using the parallax barrier has been described as a configuration of the parallax barrier, however, since the configuration of the parallax barrier may be set according to the number of required viewpoints, it is not limited to the parallax barrier, and may be the lenticular lens.

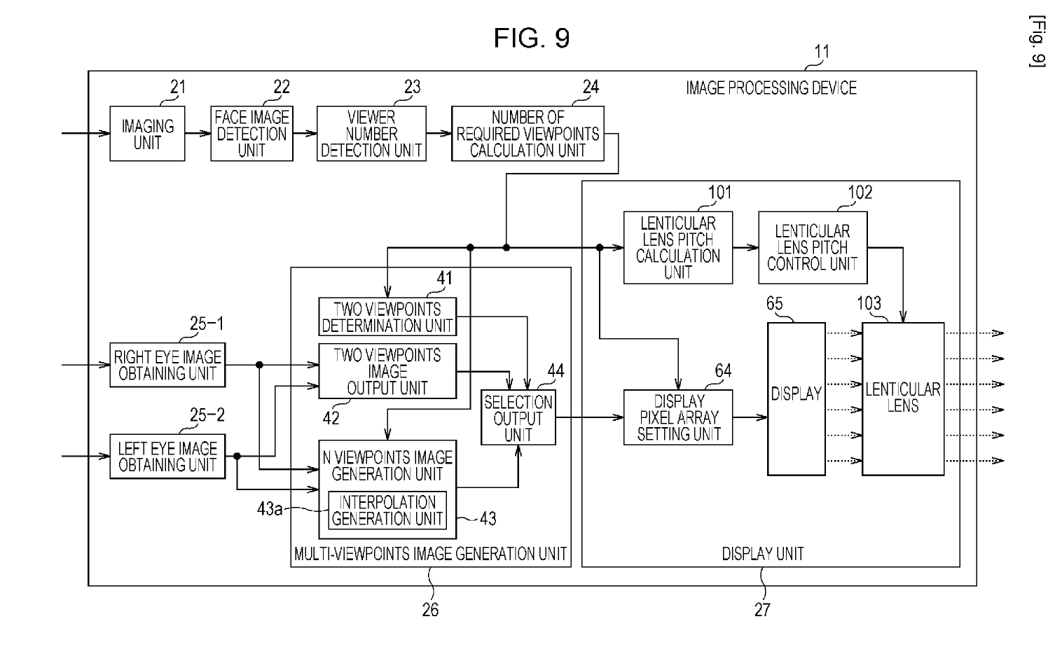

FIG. 9 show a configuration example of a third embodiment of the image processing device 11 in which the lenticular lens is used. In addition, in FIG. 9, the same number and the same reference numerals are given to a configuration having the same function as that of the image processing device 11 in FIG. 1, and descriptions thereof will be appropriately omitted.

That is, in the image processing device 11 in FIG. 9, the difference from the image processing device 11 in FIG. 1 is that the image processing device 11 in FIG. 9 includes a lenticular lens pitch calculation unit 101, a lenticular lens pitch control unit 102, and a lenticular lens 103 instead of the parallax barrier pitch calculation unit 61, the parallax barrier pitch control unit 62, and the parallax barrier 63.

The lenticular lens 103 is used for the same purpose as the parallax barrier 63, basically. The parallax barrier 63 configures the light shielding region, and configures the parallax barrier by dividing the light transmission region into slits, however, the lenticular lens 103 is configured by a liquid lens on which semi-circular unevenness is provided in the vertical direction. It has the same function as that of changing the pitch of the slit of the parallax barrier, by changing the pitch of the unevenness using a voltage supplied from the lenticular lens pitch control unit 102.

The lenticular lens pitch calculation unit 101 calculates the pitch (gap) of the unevenness of the lenticular lens 103 which corresponds to the pitch of the slit calculated by the parallax barrier pitch calculation unit 61, and supplies the calculation result to the lenticular lens pitch control unit 102.

The lenticular lens pitch control unit 102 controls the uneven pitch of the lenticular lens 103, by generating a corresponding voltage on the basis of the calculation result.

### Display Processing of Multi-Viewpoint Image Using Image Processing Device in FIG. 9

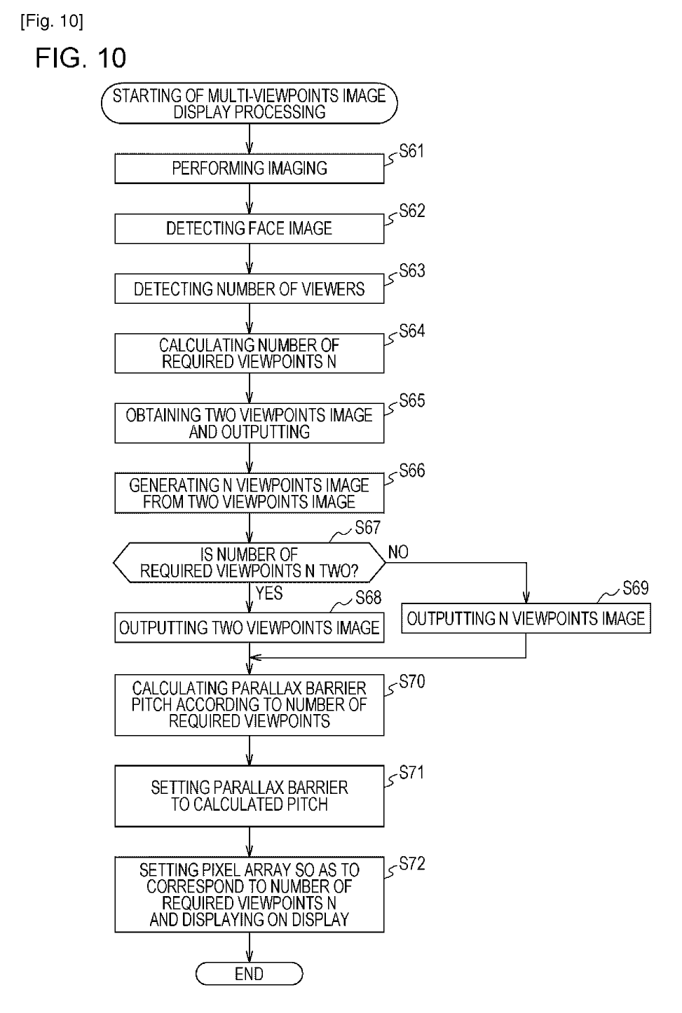

Subsequently, display processing of the multi-viewpoint image using image processing device in FIG. 9 will be described with reference to the flowchart in FIG. 10. In addition, processing of the steps S61 to S69, and S72 in the flowchart in FIG. 10 are the same as those of the steps S1 to S9, and S12 in the flowchart in FIG. 2, descriptions thereof will be omitted.

That is, when the multi-viewpoint image, or the two-viewpoint image is supplied to the display unit 27 by the processing of step S61 to S69, in step S70, the lenticular lens pitch calculation unit 101 of the display unit 27 calculates the uneven pitch (gap) in the lenticular lens 103, according to the number of required viewpoints N, and supplies the calculation result to the lenticular lens pitch control unit 102. In addition, the calculation method corresponds to the above described expression (3), descriptions thereof will be omitted.

In step S71, the lenticular lens pitch control unit 102 is set so as to provide the uneven portion at a pitch supplied from the lenticular lens pitch calculation unit 101, by controlling an applied voltage of the lenticular lens 103.

According to the above described processing, it is possible to exert the same effect as that of the image processing device 11 in FIG. 1, even if the lenticular lens 103 is used instead of the parallax barrier 63. In addition, the lenticular lens 103 has higher light intensity to be transmitted than the parallax barrier 63, it is possible for the viewer to view bright stereoscopic image to that extent. Further, similarly to the image processing device 11 in FIG. 5, it is possible to display the two-viewpoint image corresponding to the position of the viewer, by providing the viewer position detection unit 81, and by providing the N-viewpoint image generation unit 91 and the selection output unit 92 instead of the N-viewpoint image generation unit 43 and the selection output unit 44, in the image processing device 11 in FIG. 9.

As described above, according to the present technology, it is possible to display the multi-viewpoint image with the appropriate resolution corresponding to the number of viewers.

Meanwhile, the above described series of processing can be executed using hardware, however, it can be executed using software, as well. When the series of processing is executed using the software, a program configuring the software is installed to a computer built into dedicated hardware, or, for example, a general-purpose personal computer which can execute a variety of functions, by installing a variety of programs, or the like, from a recording medium.

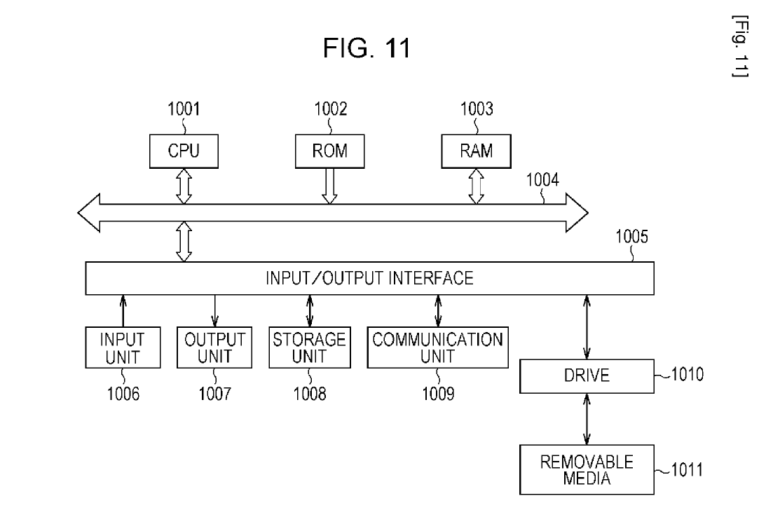

FIG. 11 shows a configuration example of a general-purpose personal computer. The personal computer includes a built-in CPU (Central Processing Unit (i.e., hardware processor) 1001. The CPU 1001 is connected with an input/output interface 1005 through a bus 1004. The bus 1004 is connected with a ROM (Read Only Memory (i.e., storage medium) 1002 and a RAM (Random Access Memory) 1003.

The input/output interface 1005 is connected with a keyboard for inputting an operation command by a user, an input unit 1006 formed of an input device such as a mouse, an output unit 1007 for outputting an image of a processing operation screen or a processing result to a display device, a storage unit 1008 which is formed of a hard disk drive or the like for storing programs, or various data, and a communication unit 1009 which is formed of a LAN (Local Area Network) adapter or the like, and executes communication processing through a network which is represented by the Internet. In addition, a magnetic disk (including flexible disk), an optical disc (including CD-ROM (Compact Disc-Read Only Memory), and DVD (Digital Versatile Disc), a magneto-optical disc (including MD (Mini Disc), or a drive 1010 which reads and writes data with respect to a removable media 1011 such as semiconductor memory is connected to the input/output interface.

The CPU 1001 executes various processing according to a program (i.e., instructions) stored in the ROM 1002, or a variety of programs (i.e., instructions) which are read out from the magnetic disk, optical disc, magneto-optical disc, or the removable media 1011 such as the semiconductor memory (any of which constitutes a non-transitory, computer-readable storage medium), are installed in the storage unit 1008, and are loaded to the RAM 1003 from the storage unit 1008. In addition, the RAM 1003 appropriately stores data or the like, which is necessary when the CPU 1001 executes various processing.

In addition, in the application, the step of describing a program which is recorded in a recording medium includes processing which is executed individually, or in parallel as well, even if they are not necessarily processed in time series, and it is needless to say to include processing which is performed in time series according to the described order.

In addition, the present technology may have a configuration described below.

(1) An apparatus, comprising:

a hardware processor; and

a storage medium coupled to the processor and storing instructions that, when executed by the processor, cause the apparatus to:

determine a number of viewers;

calculate a number of viewpoints based on the number of viewers; and

generate a plurality of images corresponding to the viewpoints.

(2) The apparatus of (1), wherein the storage medium stores instructions that, when executed by the processor, cause the apparatus to output the plurality of images to a display.

(3) The apparatus of (2), comprising the display.

(4) The apparatus of any one of (1) to (3), wherein the storage medium stores instructions that, when executed by the processor, cause the apparatus to generate the plurality of images from a left-eye image and a right-eye image.

(5) The apparatus of any one of (1) to (4), wherein the storage medium stores instructions that, when executed by the processor, cause the apparatus to determine the number of viewers based on a viewer image.

(6) The apparatus of (5), wherein the storage medium stores instructions that, when executed by the processor, cause the apparatus to determine the number of viewers by detecting a number of faces in the viewer image.

(7) The apparatus of (5) or (6), comprising an imaging unit for capturing the viewer image.

(8) The apparatus of any one of (1) to (7), wherein the storage medium stores instructions that, when executed by the processor, cause the apparatus to generate the plurality of images by one of interpolating or extrapolating the plurality of images from other images.

(9) The apparatus of any one of (1) to (4), wherein the storage medium stores instructions that, when executed by the processor, cause the apparatus to generate the plurality of images based on a viewer position.

(10) The apparatus of (9), comprising an imaging unit for capturing a viewer image, wherein the storage medium stores instructions that, when executed by the processor, cause the apparatus to determine the viewer position based on the viewer image.

(11) The apparatus of any one of (1) to (10), wherein the storage medium stores instructions that, when executed by the processor, cause the apparatus to calculate a pitch, based on the number of viewpoints, for controlling a parallax barrier.

(12) The apparatus of (11), comprising the parallax barrier.

(13) The apparatus of any one of (1) to (10), wherein the storage medium stores instructions that, when executed by the processor, cause the apparatus to calculate a pitch, based on the number of viewpoints, for controlling a lenticular lens.

(14) The apparatus of (13), comprising the lenticular lens.

Although some embodiments have been described in detail with reference to the accompanying drawings, the present disclosure is not limited to such embodiments. It should be understood by those skilled in the art that various modifications, combinations, sub-combinations and alterations may occur depending on design requirements and other factors insofar as they are within the scope of the appended claims or the equivalents thereof. Further, it should be understood that, as used herein, the indefinite articles “a” and “an” mean “one or more” in open-ended claims containing the transitional phrase “comprising,” “including,” and/or “having.”

### REFERENCE SIGNS LIST

11: IMAGE PROCESSING DEVICE
21: IMAGING UNIT
22: FACE IMAGE DETECTION UNIT
23: VIEWER NUMBER DETECTION UNIT
24: REQUIRED VIEWPOINTS NUMBER DETECTION UNIT
25-1: RIGHT EYE IMAGE OBTAINING UNIT
25-2: LEFT EYE IMAGE OBTAINING UNIT
26: MULTI-VIEWPOINTS IMAGE GENERATION UNIT
27: DISPLAY UNIT
41: TWO-VIEWPOINT DETERMINATION UNIT
42: TWO-VIEWPOINT IMAGE OUTPUT UNIT
43: N-VIEWPOINTS IMAGE GENERATION UNIT
44: SELECTION OUTPUT UNIT
61: PARALLAX BARRIER PITCH CALCULATION UNIT
62: PARALLAX BARRIER PITCH CONTROL UNIT
63: PARALLAX BARRIER
64: DISPLAY PIXEL ARRAY SETTING UNIT
65: DISPLAY
81: VIEWER POSITION DETECTION UNIT
82: MULTI-VIEWPOINT IMAGE OBTAINING UNIT
91: N-VIEWPOINTS IMAGE SELECTION UNIT
101: LENTICULAR LENS PITCH CALCULATION UNIT
102: LENTICULAR LENS PITCH CONTROL UNIT
103: LENTICULAR LENS

1. An apparatus, comprising:
a hardware processor; and
a storage medium coupled to the processor and storing instructions that, when executed by the processor, cause the apparatus to:
determine a number of viewers;
calculate a number of viewpoints based on the number of viewers; and
generate a plurality of images corresponding to the viewpoints.

2. The apparatus of claim 1, wherein the storage medium stores instructions that, when executed by the processor, cause the apparatus to output the plurality of images to a display.

3. The apparatus of claim 2, comprising the display.

4. The apparatus of claim 1, wherein the storage medium stores instructions that, when executed by the processor, cause the apparatus to generate the plurality of images from a left-eye image and a right-eye image.

5. The apparatus of claim 1, wherein the storage medium stores instructions that, when executed by the processor, cause the apparatus to determine the number of viewers based on a viewer image.

6. The apparatus of claim 5, wherein the storage medium stores instructions that, when executed by the processor, cause the apparatus to determine the number of viewers by detecting a number of faces in the viewer image.

7. The apparatus of claim 6, comprising an imaging unit for capturing the viewer image.

8. The apparatus of claim 1, wherein the storage medium stores instructions that, when executed by the processor, cause the apparatus to generate the plurality of images by one of interpolating or extrapolating the plurality of images from other images.

9. The apparatus of claim 1, wherein the storage medium stores instructions that, when executed by the processor, cause the apparatus to generate the plurality of images based on a viewer position.

10. The apparatus of claim 9, comprising an imaging unit for capturing a viewer image, wherein the storage medium stores instructions that, when executed by the processor, cause the apparatus to determine the viewer position based on the viewer image.

11. The apparatus of claim 1, wherein the storage medium stores instructions that, when executed by the processor, cause the apparatus to calculate a pitch, based on the number of viewpoints, for controlling a parallax barrier.

12. The apparatus of claim 11, comprising the parallax barrier.

13. The apparatus of claim 1, wherein the storage medium stores instructions that, when executed by the processor, cause the apparatus to calculate a pitch, based on the number of viewpoints, for controlling a lenticular lens.

14. The apparatus of claim 13, comprising the lenticular lens.

15. A method, comprising:
determining a number of viewers;
calculating a number of viewpoints based on the number of viewers; and
generating a plurality of images corresponding to the viewpoints.

16. A non-transitory, computer-readable storage medium storing instructions that, when executed by a processor, cause an apparatus to:
determine a number of viewers;
calculate a number of viewpoints based on the number of viewers; and
generate a plurality of images corresponding to the viewpoints.
